(19) United States
(12) Patent Application Publication
(10) Pub. No.: US 2026/0302610 A1
(43) Pub. Date: Oct. 1, 2026

(54) DOUBLE-AXIS ROTATING ANTENNA STRUCTURE

(71) Applicant: WNC Corporation, Hsinchu (TW)

(72) Inventor: Yu-Kai CHIU, Hsinchu (TW)

(21) Appl. No.: 19/414,401

(22) Filed: Dec. 10, 2025

(30) Foreign Application Priority Data
Mar. 27, 2025 (TW) 114111713

(51) Int. Cl. H01Q 3/08; F16H 37/12; H01Q 1/02

(52) U.S. Cl. CPC H01Q 3/08; F16H 37/122; H01Q 1/02

(57) ABSTRACT

A double-axis rotating antenna structure includes a base, a yaw rotating frame, an antenna assembly, a pitch rotating linkage assembly and a driving mechanism. The base includes a central gear. The antenna assembly is pivotally disposed at the yaw rotating frame and includes an antenna disc. The pitch rotating linkage assembly is connected to the antenna assembly. The driving mechanism is disposed at the yaw rotating frame and includes a worm shaft, a motor and a planet gear. The worm shaft is connected to the pitch rotating linkage assembly. The motor is connected to and drives the worm shaft. The planet gear is engaged with the central gear and is driven by the worn gear. The motor rotates the worm shaft to actuate the pitch linkage assembly to pitch the antenna disc and drive the planet gear to yaw the antenna disc.

### RELATED APPLICATIONS

This application claims the benefit of priority to Taiwan Patent Application No. 114111713, filed on Mar. 27, 2025. The entire content of the above identified application is incorporated herein by reference.

### BACKGROUND

### Technical Field

The present disclosure relates to an antenna structure, in particular to a double-axis rotating antenna structure.

### Description of Related Art

In general, when an antenna disc is installed, the installer has to try multiple different orientations of the antenna disc to search for the best reception angle, and then mechanically fixes it (for example, by screwing) at the designated orientation. When the radiation direction of the signal source changes, such as being affected by the rotation of the earth, changes in the environmental conditions of the base station, or the signal pointing toward a secondary base station caused by damage of the main base station, the orientation of the antenna disc needs to be manually adjusted again.

Accordingly, some manufacturers mount the antenna disc on a platform that can perform yaw rotation and pitch rotation, thereby adjusting along two rotation dimensions to find the optimal angle. However, such double-axis rotating antenna structures usually adopt two motors to achieve movements in the two dimensions. This not only increases the cost of product components but also raises the difficulty of firmware control, while also leads to issues such as angle calibration, control circuit pin occupation, and reliability concerns. Therefore, there is still room for improvement.

### SUMMARY

One aspect of the present disclosure is to provide a double-axis rotating antenna structure including a base, a yaw rotating frame, an antenna assembly, a pitch rotating linkage assembly, and a driving mechanism. The base includes a central gear. The yaw rotating frame is movably disposed at the base and yaws relative to the base. The antenna assembly is pivotally disposed at the yaw rotating frame and includes an antenna disc. One end of the pitch rotating linkage assembly is connected to the antenna assembly. The driving mechanism is disposed at the yaw rotating frame and includes a worm shaft, a motor, and a planet gear. The worm shaft is connected to the other end of the pitch rotating linkage assembly and rotates about a first axis. The motor is connected to and drives the worm shaft. The planet gear is engaged with the central gear and is driven by the worm shaft to rotate about a second axis, the second axis being orthogonal to the first axis. The motor rotates to drive the worm shaft to actuate the pitch rotating linkage assembly to pitch the antenna disc, and simultaneously drives the planet gear to move circumferentially along the central gear to yaw the antenna disc.

Another aspect of the present disclosure is to provide a double-axis rotating antenna structure including a base, a yaw rotating frame, an antenna assembly, a pitch rotating linkage assembly, and a driving mechanism. The base includes a central gear. The yaw rotating frame is movably disposed at the base and yaws relative to the base. The antenna assembly is pivotally disposed at the yaw rotating frame and includes an antenna disc. The pitch rotating linkage assembly includes a transmission link and a driving link. One end of the transmission link is pivotally connected to the antenna assembly. One end of the driving link is pivotally connected to the other end of the transmission link. The driving mechanism is configured to drive the driving link and includes a worm shaft, a motor, and a planet gear. The worm shaft is connected to the other end of the driving link and is orthogonal to the driving link. The motor is connected to and drives the worm shaft. The planet gear is engaged with the central gear and is driven by the worm shaft to rotate. The motor rotates to drive the worm shaft to actuate the pitch rotating linkage assembly to pitch the antenna disc, and simultaneously drives the planet gear to move circumferentially along the central gear to yaw the antenna disc.

### BRIEF DESCRIPTION OF THE DRAWINGS

The present disclosure can be more fully understood by reading the following detailed description of the embodiment, with reference made to the accompanying drawings as follows:

FIG. 1 illustrates a three-dimensional perspective view of a double-axis rotating antenna structure according to one embodiment of the present disclosure.

FIG. 2 illustrates an exploded view of the double-axis rotating antenna structure of the embodiment of FIG. 1.

FIG. 3 illustrates a partial side view of the double-axis rotating antenna structure of the embodiment of FIG. 1.

FIG. 4 illustrates a schematic diagram of an equivalent linkage of the double-axis rotating antenna structure of the embodiment of FIG. 1.

FIG. 5 illustrates a partial side view of the operating state of the double-axis rotating antenna structure of the embodiment of FIG. 1.

FIG. 6 illustrates a partial top view of the double-axis rotating antenna structure of the embodiment of FIG. 1.

### DETAILED DESCRIPTION

The present disclosure is more particularly described in the following embodiments that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an” and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

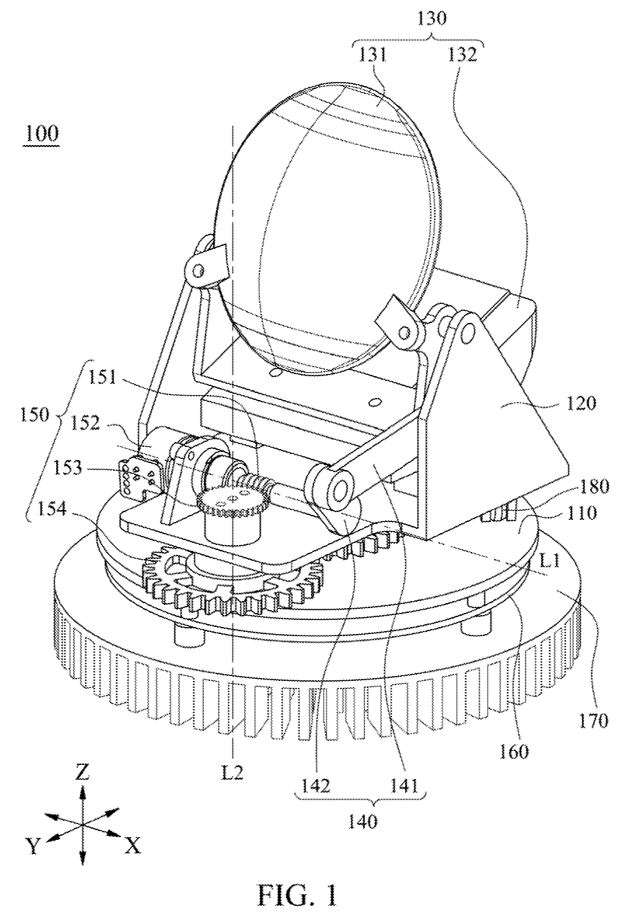

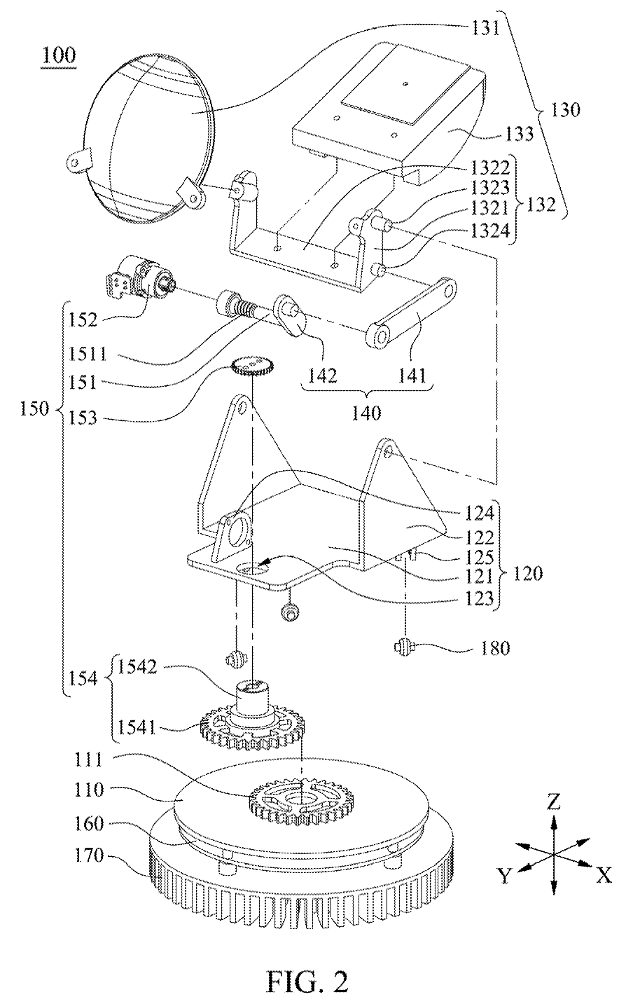

Referring to FIGS. 1 and 2, FIG. 1 illustrates a three-dimensional perspective view of a double-axis rotating antenna structure 100 according to one embodiment of the present disclosure, and FIG. 2 illustrates an exploded view of the double-axis rotating antenna structure 100 of the embodiment of FIG. 1. The double-axis rotating antenna structure 100 includes a base 110, a yaw rotating frame 120, an antenna assembly 130, a pitch rotating linkage assembly 140, and a driving mechanism 150.

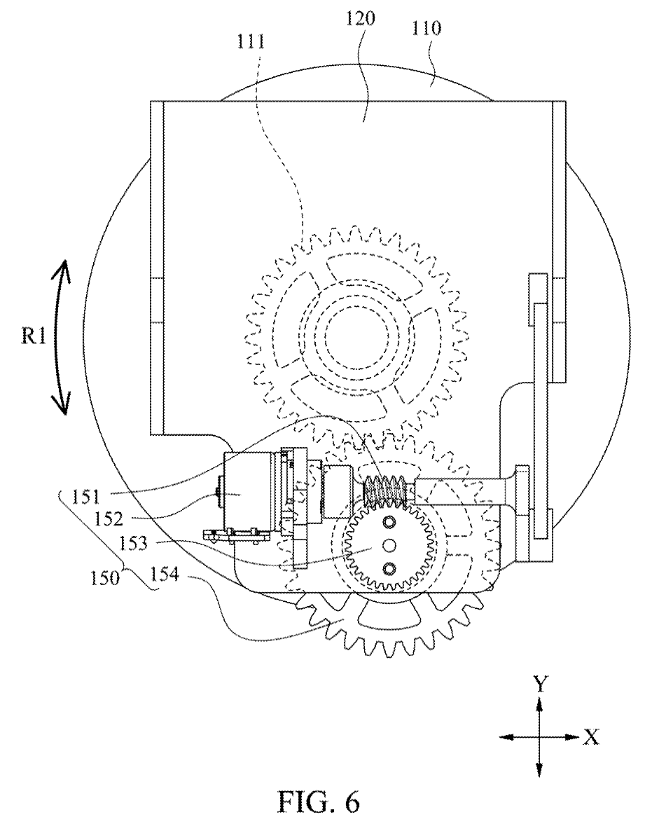

The base 110 includes a central gear 111. The yaw rotating frame 120 is movably disposed at the base 110 and yaws relative to the base 110. The antenna assembly 130 is pivotally disposed at the yaw rotating frame 120 and includes an antenna disc 131. One end of the pitch rotating linkage assembly 140 is connected to the antenna assembly 130. The driving mechanism 150 is disposed at the yaw rotating frame 120 and includes a worm shaft 151, a motor 152, and a planet gear 154. The worm shaft 151 is connected to the other end of the pitch rotating linkage assembly 140. The motor 152 is connected to and drives the worm shaft 151. The planet gear 154 is engaged with the central gear 111 and is driven to rotate by the worm shaft 151. The motor 152 rotates to drive the worm shaft 151 to actuate the pitch rotating linkage assembly 140 to pitch the antenna disc 131, and simultaneously drives the planet gear 154 to move circumferentially along the central gear 111 in a circumferential direction R1 (illustrated in FIG. 6) to yaw the antenna disc 131.

Thus, the driving mechanism 150 can drive both yawing and pitching of the antenna disc 131 through a single motor 152, thereby achieving structural simplification and cost reduction.

The base 110 is generally disc-shaped, the central gear 111 may protrude from the upper surface of the base 110, and the central gear 111 includes a gear hole. The body of the base 110 and the central gear 111 may be integrally formed by plastic molding. The double-axis rotating antenna structure 100 may further include a control circuit board 160 and a heat dissipation plate 170, which are stacked on one side of the base 110 opposite to the yaw rotating frame 120. The control circuit board 160 may be used to control the driving mechanism 150, and the heat dissipation plate 170 may provide heat dissipation for the control circuit board 160.

The yaw rotating frame 120 may include a bottom plate 121 and two arms 122, the two arms 122 being protruded at intervals from the bottom plate 121. The yaw rotating frame 120 may further include a limiting protrusion (not shown), which protrudes from a lower surface of the bottom plate 121 toward the base 110, and is pivotally disposed in the gear hole, allowing the yaw rotating frame 120 to yaw relative to the base 110, that is, to rotate in the X-axis-Y-axis plane.

The bottom plate 121 is elongated and includes two side edges. Each arm 122 is connected to a respective side edge and arranged opposite to each other, thereby forming a supporting structure for pivotally disposing the antenna assembly 130 thereon. The yaw rotating frame 120 may further include a through hole 123 and a motor fixing portion 124. The through hole 123 penetrates the bottom plate 121, and the motor fixing portion 124 protrudes upward from an upper surface of the bottom plate 121, so that the motor 152 can be fixed thereto.

Furthermore, the double-axis rotating antenna structure 100 may further include a plurality of rollers 180. The rollers 180 are pivotally disposed at intervals on a lower surface of the bottom plate 121 and contact the base 110. As shown in FIG. 2, a number of rollers 180 is three. The yaw rotating frame 120 may further include three pivot seats 125, which are disposed at intervals on the lower surface of the bottom plate 121, and each roller 180 is pivotally disposed on a respective pivot seat 125. Accordingly, each roller 180 provides rotational support to prevent deformation of the bottom plate 121 caused by gravity. In addition, the rollers 180 can improve the smoothness of the yaw rotating frame 120 relative to the base 110 when rotating, and can replace bearings to reduce cost.

The motor 152 of the driving mechanism 150 may be fixed to the motor fixing portion 124, and one end of the worm shaft 151 may be directly connected to an output shaft of the motor 152. The extending direction of the worm shaft 151 may be parallel to a first axis L1 and include a plurality of worm teeth 1511. When the motor 152 drives the worm shaft 151, the worm shaft 151 may rotate about the first axis L1. The driving mechanism 150 may further include a worm gear 153 engaged with the worm shaft 151, particularly engaged with the worm teeth 1511. The planet gear 154 may include a gear disc 1541 and a cylindrical portion 1542. The gear disc 1541 is engaged with the central gear 111, and the cylindrical portion 1542 extends upward from the gear disc 1541 and passes through the through hole 123. The worm gear 153 is locked to one end of the cylindrical portion 1542.

Specifically, the worm gear 153 is rotatably located above the bottom plate 121, and the planet gear 154 may be located below the bottom plate 121, with the cylindrical portion 1542 passing through the through hole 123 to connect with the worm gear 153. In this way, the planet gear 154 can be confined within the yaw rotating frame 120 and rotate together with the worm gear 153. Therefore, when the motor 152 rotates, the worm teeth 1511 on the worm shaft 151 rotate, and the worm gear 153 and the planet gear 154 are driven to rotate about a second axis L2. Since the center of the base 110 is pivotally connected to the center of the yaw rotating frame 120, the planet gear 154 is engaged with the central gear 111. Accordingly, the planet gear 154 can further drive the yaw rotating frame 120 to move along the circumferential direction R1 of the central gear 111, thereby yawing the antenna disc 131. The second axis L2 may be orthogonal to the first axis L1. In FIG. 1, the first axis L1 may be parallel to the X-axis, and the second axis L2 may be parallel to the Z-axis.

The antenna assembly 130 may be pivotally connected to the two arms 122. Specifically, the antenna assembly 130 may further include an antenna support frame 132. The antenna support frame 132 is connected to the antenna disc 131 and pivotally connected between the two arms 122. The antenna support frame 132 further includes two arm portions 1321 and a locking plate portion 1322. The two arm portions 1321 protrude from the locking plate portion 1322 at intervals. The antenna disc 131 is connected between the two arm portions 1321, and the two arm portions 1321 are pivotally connected to the two arms 122, respectively.

The locking plate portion 1322 and the two arm portions 1321 are connected to form an n-shaped structure. Each locking plate portion 1322 includes a locking hole facing the antenna disc 131, enabling the antenna disc 131 to be lockingly fixed thereto. The antenna support frame 132 may further include two arm pivot shafts 1323, which protrude outward from outer surfaces of the arm portions 1321, respectively, and are pivotally connected to pivot holes of the two arms 122. The antenna support frame 132 may further include a linkage pivot shaft 1324, which protrudes outward from an outer surface of one of the arm portions 1321 and is arranged in a spaced manner along the extending direction of the arm portion 1321 with respect to the arm pivot shaft 1323. In addition, the antenna assembly 130 may further include a heat dissipation member 133, which may be lockingly connected to the locking plate portion 1322. Specifically, the heat dissipation member 133 is lockingly connected to a surface of the locking plate portion 1322 opposite to the arm portions 1321, and the heat dissipation member 133 may include a flat surface for mounting an antenna circuit board thereon.

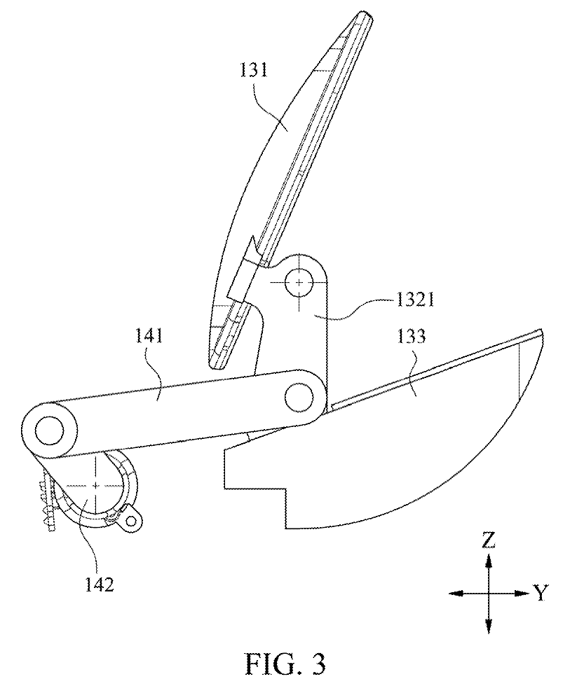

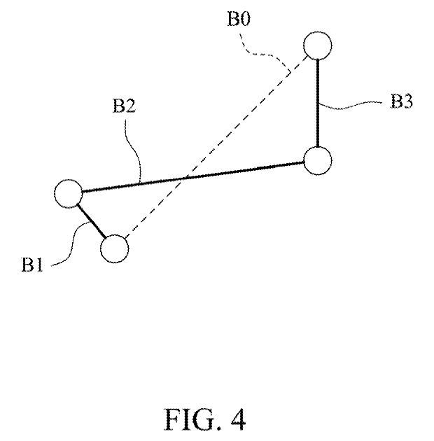

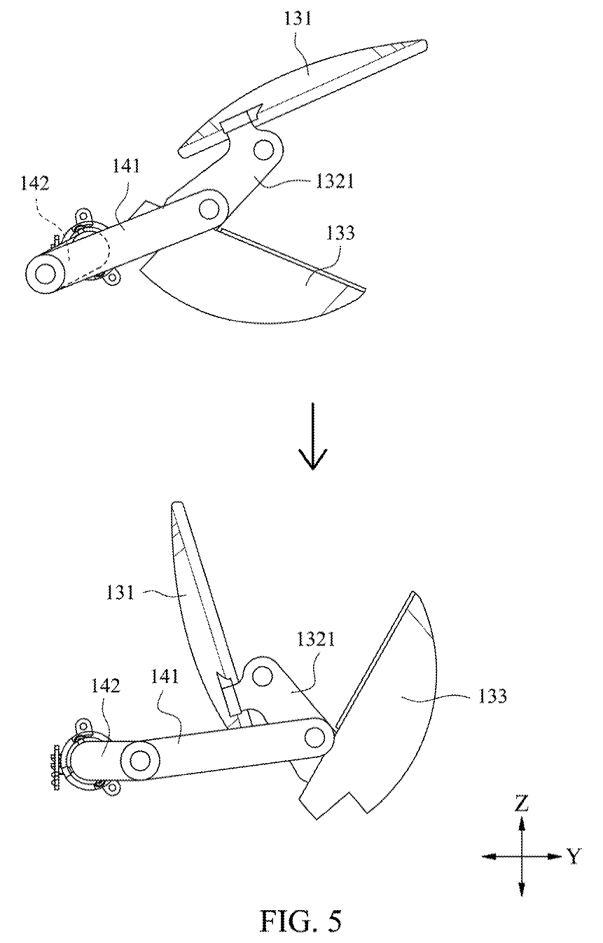

Referring to FIGS. 3, 4 and 5, and also to FIGS. 1 and 2, FIG. 3 illustrates a partial side view of the double-axis rotating antenna structure 100 of the embodiment of FIG. 1, FIG. 4 illustrates a schematic diagram of an equivalent linkage of the double-axis rotating antenna structure 100 of the embodiment of FIG. 1, and FIG. 5 illustrates a partial side view of the operating state of the double-axis rotating antenna structure 100 of the embodiment of FIG. 1. It should be noted that FIGS. 3 and 5 only illustrate partial components of the double-axis rotating antenna structure 100 and do not limit the present disclosure. The pitch rotating linkage assembly 140 is used to drive the antenna assembly 130 to pitch, and may include a transmission link 141 and a driving link 142. The transmission link 141 is pivotally connected to one of the two arm portions 1321. The driving link 142 may be pivotally connected between the transmission link 141 and the worm shaft 151. Specifically, the extending direction of the driving link 142 is perpendicular to the worm shaft 151, and two ends of the driving link 142 are pivotally connected to the transmission link 141 and the worm shaft 151, respectively. The extending direction of the transmission link 141 is also perpendicular to the worm shaft 151, and one end of the transmission link 141 is pivotally connected to the driving link 142 to form a variable included angle, while the other end of the transmission link 141 may be pivotally connected to the linkage pivot shaft 1324.

Accordingly, a planar four-bar linkage mechanism can be formed as shown in FIG. 4. The driving link 142 may be equivalent to a link B1, the transmission link 141 may be equivalent to a link B2, the line connecting the linkage pivot shaft 1324 on the arm portion 1321 and the arm pivot shaft 1323 may be equivalent to a link B3, and the line connecting the aforementioned end of the worm shaft 151 (a fixed point) and the linkage pivot shaft 1324 (a fixed point) to which the driving link 142 is connected may be equivalent to a link B0. When the link B1 performs continuous rotation, the link B3 can oscillate relative to the fixed point.

In configuration, the length of the driving link 142 and the length of each arm portion 1321 may be smaller than the length of the transmission link 141, wherein the length refers to the distance between pivot points. Furthermore, the lengths of the links B1 and B3 must be smaller than those of the links B0 and B2. The lengths of the links B1 and B3 may be equal, and the lengths of the links B0 and B2 may be equal, but both equalities cannot exist simultaneously.

As shown in FIG. 5, by the rotation of the worm shaft 151, the driving link 142 can be rotated around the first axis L1, thereby driving the transmission link 141 to pull the antenna assembly 130. The antenna assembly 130 pivots around the linkage pivot shaft 1324 to perform pitching rotation, such that the antenna disc 131 swings between a first pitch position and a second pitch position. The angular difference between the first pitch position and the second pitch position is greater than or equal to 65 degrees and less than or equal to 85 degrees, for example, 77.17 degrees.

Referring to FIG. 6, and also to FIGS. 1 and 2, FIG. 6 illustrates a partial top view of the double-axis rotating antenna structure 100 of the embodiment of FIG. 1. In this embodiment, when the motor 152 rotates, both yawing and pitching of the antenna assembly 130 can be simultaneously achieved. Therefore, while the antenna assembly 130 continuously pitches back and forth, yawing movement can be performed slowly, which facilitates achieving global scanning. Thus, the yaw angle of the yaw rotating frame 120 is θ_{yaw}, the rotation angle of the motor 152 is φₘ, the pitch circle diameter of the planet gear 154 is Dₚ, the pitch circle diameter of the central gear 111 is D_{c}, and the number of worm teeth of the worm shaft 151 is T_{w}, satisfying the relationship of θ_{yaw} = (φₘ × Dₚ) / (T_{w} × D_{c}).

The rotation angle φₘ of the motor 152 may be cumulative. The pitch circle diameter Dₚ is the distance from the center point of the planet gear 154 to the contact point between the planet gear 154 and the central gear 111. The pitch circle diameter D_{c} is the distance from the center point of the central gear 111 to the contact point between the central gear 111 and the planet gear 154. The number of teeth T_{w} refers to the number of worm teeth 1511.

Therefore, when the motor 152 rotates one circle, the spatial directivity of the antenna assembly 130 follows a fixed curve attached to a harmonic curve on the spatial sphere. This spatial directivity is only related to the rotation angle φₘ of the motor 152, and can be regarded as a one-dimensional function of the rotation angle φₘ of the motor 152. Hence, it has uniqueness, which is advantageous for scanning and searching algorithms for optimal signals. For example, if the scanning range is from a rotation angle φₘ of +3600 degrees to -3600 degrees, that is, a search range corresponding to the motor 152 rotating ten circles in the positive and negative directions, and if the optimal signal is located at 456 degrees, because the pointing position is uniquely related to the rotation angle φ ₘ, it is easy to return to the detected optimal signal position, thereby achieving an accurate return to the optimal position.

In addition to achieving the advantageous effects of structural simplification, cost reduction, and accurate return to the optimal position, the present disclosure also improves product reliability by reducing the number of motors. Assuming that the reliability of one motor within a certain period is 95%, if a design uses two motors, the system reliability can be regarded as a series system, and the reliability becomes the product of the two motors, i.e., 90.25%, resulting in decreased reliability. Therefore, by reducing the number of motors, product reliability can be improved.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A double-axis rotating antenna structure, comprising:
a base, comprising a central gear;
a yaw rotating frame, movably disposed at the base and yawing relative to the base;
an antenna assembly, pivotally disposed at the yaw rotating frame and comprising an antenna disc;
a pitch rotating linkage assembly, one end thereof connected to the antenna assembly; and
a driving mechanism, disposed at the yaw rotating frame and comprising:
a worm shaft, connected to another end of the pitch rotating linkage assembly and rotating about a first axis;
a motor, connected to and driving the worm shaft; and
a planet gear, engaged with the central gear and driven by the worm shaft to rotate about a second axis, the second axis being orthogonal to the first axis;
wherein the motor rotates to drive the worm shaft to actuate the pitch rotating linkage assembly to pitch the antenna disc, and simultaneously drives the planet gear to move circumferentially along the central gear to yaw the antenna disc.

2. The double-axis rotating antenna structure according to claim 1, wherein the yaw rotating frame comprises a bottom plate and two arms, the two arms protrude from the bottom plate at intervals, and the antenna assembly further comprises an antenna support frame connected to the antenna disc and pivotally connected between the two arms.

3. The double-axis rotating antenna structure according to claim 2, wherein the antenna support frame further comprises two arm portions and a locking plate portion, the two arm portions protrude from the locking plate portion at intervals, the antenna disc is connected between the two arm portions, the two arm portions are pivotally connected to the two arms, respectively, and the pitch rotating linkage assembly comprises a transmission link pivotally connected to one of the two arm portions.

4. The double-axis rotating antenna structure according to claim 3, wherein the pitch rotating linkage assembly further comprises a driving link pivotally connected between the transmission link and the worm shaft.

5. The double-axis rotating antenna structure according to claim 4, wherein a length of the driving link and a length of each of the two arm portions are smaller than a length of the transmission link.

6. The double-axis rotating antenna structure according to claim 3, wherein the antenna assembly further comprises a heat dissipation member lockingly connected to the locking plate portion.

7. The double-axis rotating antenna structure according to claim 2, wherein the yaw rotating frame further comprises a through hole penetrating the bottom plate, the driving mechanism further comprises a worm gear engaged with the worm shaft, the planet gear comprises a gear disc and a cylindrical portion, the gear disc is engaged with the central gear, the cylindrical portion extends upward from the gear disc and passes through the through hole, and the worm gear is locked to one end of the cylindrical portion.

8. The double-axis rotating antenna structure according to claim 1, wherein the antenna disc swings between a first pitch position and a second pitch position, and an angular difference between the first pitch position and the second pitch position is greater than or equal to 65 degrees and less than or equal to 85 degrees.

9. The double-axis rotating antenna structure according to claim 1, wherein a yaw angle of the yaw rotating frame is θ_{yaw} a rotation angle of the motor is φₘ a pitch circle diameter of the planet gear is Dₚ a pitch circle diameter of the central gear is D_{c} and a number of teeth of the worm shaft is T_{w} satisfying a relationship of θ_{yaw} = (φₘ × Dₚ) / (T_{w} × D_{c}).

10. The double-axis rotating antenna structure according to claim 1, further comprising a control circuit board and a heat dissipation plate, the control circuit board and the heat dissipation plate being stacked on one side of the base opposite to the yaw rotating frame.

11. A double-axis rotating antenna structure, comprising:
a base, comprising a central gear;
a yaw rotating frame, movably disposed at the base and yawing relative to the base;
an antenna assembly, pivotally disposed at the yaw rotating frame and comprising an antenna disc;
a pitch rotating linkage assembly, comprising:
a transmission link, one end thereof pivotally connected to the antenna assembly; and
a driving link, one end thereof pivotally connected to another end of the transmission link; and
a driving mechanism configured to drive the driving link and comprising:
a worm shaft, connected to another end of the driving link, the worm shaft being orthogonal to the driving link;
a motor, connected to and driving the worm shaft; and
a planet gear, engaged with the central gear and driven by the worm shaft to rotate;
wherein the motor rotates to drive the worm shaft to actuate the pitch rotating linkage assembly to pitch the antenna disc, and simultaneously drives the planet gear to move circumferentially along the central gear to yaw the antenna disc.

12. The double-axis rotating antenna structure according to claim 11, wherein the yaw rotating frame comprises a bottom plate and two arms, the two arms protrude from the bottom plate at intervals, and the antenna assembly further comprises an antenna support frame connected to the antenna disc and pivotally connected between the two arms.

13. The double-axis rotating antenna structure according to claim 12, wherein the antenna support frame further comprises two arm portions and a locking plate portion, the two arm portions protrude from the locking plate portion at intervals, the antenna disc is connected between the two arm portions, the two arm portions are pivotally connected to the two arms, respectively, and the transmission link is pivotally connected to one of the two arm portions.

14. The double-axis rotating antenna structure according to claim 13, wherein a length of the driving link and a length of each of the two arm portions are smaller than a length of the transmission link.

15. The double-axis rotating antenna structure according to claim 14, wherein the antenna assembly further comprises a heat dissipation member lockingly connected to the locking plate portion.

16. The double-axis rotating antenna structure according to claim 12, wherein the yaw rotating frame further comprises a through hole penetrating the bottom plate, the driving mechanism further comprises a worm gear engaged with the worm shaft, the planet gear comprises a gear disc and a cylindrical portion, the gear disc is engaged with the central gear, the cylindrical portion extends upward from the gear disc and passes through the through hole, and the worm gear is locked to one end of the cylindrical portion.

17. The double-axis rotating antenna structure according to claim 12, wherein the yaw rotating frame further comprises a plurality of rollers, and the rollers are pivotally disposed at intervals on a lower surface of the bottom plate and contact the base.

18. The double-axis rotating antenna structure according to claim 11, wherein the antenna disc swings between a first pitch position and a second pitch position, and an angular difference between the first pitch position and the second pitch position is greater than or equal to 65 degrees and less than or equal to 85 degrees.

19. The double-axis rotating antenna structure according to claim 11, wherein a yaw angle of the yaw rotating frame is θ_{yaw} a rotation angle of the motor is φₘ a pitch circle diameter of the planet gear is Dₚ a pitch circle diameter of the central gear is D_{c} and a number of teeth of the worm shaft is T_{w} satisfying a relationship of θ_{yaw} = (φₘ × Dₚ) / (T_{w} × D_{c}).

20. The double-axis rotating antenna structure according to claim 11, further comprising a control circuit board and a heat dissipation plate, the control circuit board and the heat dissipation plate being stacked on one side of the base opposite to the yaw rotating frame.
